(19) United States
(12) Patent Application Publication
(10) Pub. No.: US 2015/0047053 A1
(43) Pub. Date: Feb. 12, 2015

(54) SERVER, TERMINAL, AND TRANSFER METHOD FOR DIGITAL CONTENT UNDER COPYRIGHT PROTECTION

(71) Applicants: PEKING UNIVERSITY FOUNDER GROUP CO., LTD., Beijing (CN); FOUNDER APABI TECHNOLOGY LIMITED, BEIJING (CN)

(72) Inventors: Yilei CHEN, Beijing (CN); Wei Wan, Beijing (CN)

(73) Assignees: FOUNDER APABI TECHNOLOGY LIMITED, Beijing (CN); PEKING UNIVERSITY FOUNDER GROUP CO., LTD., Beijing (CN)

(21) Appl. No.: 14/101,562

(22) Filed: Dec. 10, 2013

(30) Foreign Application Priority Data
Aug. 8, 2013 (CN) 201310344313.4

(51) Int. Cl. G06F 21/10; H04L 29/06

(52) U.S. Cl. CPC G06F 21/105; H04L 63/08
USPC 726/28

(57) ABSTRACT

A server, comprising a communication unit for receiving a user identifier and a unique identifier of digital content to be transferred from a first terminal, and feeding back intermediate information to the first terminal, and for receiving intermediate information and second terminal device information from a second terminal, and sending a license to the second terminal; a rights acquisition unit for acquiring rights information of the digital content to be transferred; a generation unit for generating the intermediate information; an authentication unit for authenticating the intermediate information from the second terminal; a license generation unit for generating a license. Information may be generated according to user identifier of the transferor and rights information of the digital content. The acceptor may gain use rights of the digital content based on received intermediate information, so that transfer flow of the digital content is optimized, leading to more convenient user operations.

### CROSS-REFERENCE TO RELATED APPLICATIONS

This application claims priority to Chinese Patent Application No. 201310344313.4, filed on Aug. 8, 2013 and entitled “SERVER, TERMINAL, AND TRANSFER METHOD FOR DIGITAL CONTENT UNDER COPYRIGHT PROTECTION”, which is incorporated herein by reference in its entirety.

### FIELD OF THE INVENTION

The present invention relates to the electronic information field, and more particular, to a server, a terminal and a method of transferring a digital content under copyright protection.

### DESCRIPTION OF THE RELATED ART

With the popularity of electronic resources, digital contents are becoming increasingly widespread in use, and for the purpose of copyright protection of digital contents, digital content providers perform copyright management based on DRM (Digital Rights Management) licenses. When a user wants to use a digital content, he/she may use the digital resource content normally on a specified device only after authorization by a digital content provider according to an identifier of the user and the specified device; and if the user wants to replace the device later, the digital content provider has to re-authorize the new device.

In a related technical solution, digital content providers have to authorize users and specified devices, or a user has to bind a digital content, user identifier information and a specified device to use the digital content under copyright protection normally. If a present user wants to transfer a present digital content to an acceptor, he/she has to provide user identifier information of the transferor (i.e., the present user) to the acceptor, and then rebind the digital content to user identifier information of the acceptor and device information of the acceptor.

The above transfer flow of digital contents under copyright protection is complex, in which the acceptor must own a user identifier provided by the transferor, and then apply for authorization according to the user identifier of the transferor; in the case of being authorized, the digital content may be used normally only after the digital content is bound to user identifier information of the acceptor and a device used by the acceptor. If it is needed to transfer a digital content to multiple acceptors, each acceptor has to perform the same tedious operation repeatedly according to the user identifier provided by the transferor, and seek authorization for device information corresponding to the acceptors respectively, so as to use the received digital content normally.

Thus, how to improve transfer efficiency for digital contents under copyright protection and to ensure the security of digital contents under copyright protection is a technical problem to be solved.

### SUMMARY OF THE INVENTION

In view of the above problems, this invention proposes a new solution for transferring a digital content under copyright protection, in which intermediate information may be generated according to a user identifier of a transferor and rights information of the digital content; an acceptor may acquire use rights of the digital content according to the received intermediate information, so that the transfer flow of the digital content is optimized, allowing more convenient user operations.

Thus, according to an aspect of this invention, a server is provided, comprising: a communication unit, for receiving a user identifier and a unique identifier of a digital content to be transferred from a first terminal, and feeding back intermediate information generated by an intermediate information generation unit to the first terminal; and receiving intermediate information and second terminal device information from a second terminal, and sending a license generated by a license generation unit to the second terminal; a rights acquisition unit for acquiring, according to the user identifier and the unique identifier of the digital content to be transferred, rights information of the digital content to be transferred; the intermediate information generation unit, for generating the intermediate information according to the user identifier and the rights information of the digital content to be transferred; an authentication unit, for authenticate the intermediate information from the second terminal; the license generation unit, for generating, after the authentication for the intermediate information of the second terminal is passed, a license according to the user identifier, the second terminal device information and the rights information of the digital content to be transferred.

In this technical solution, the server generates intermediate information according to the user identifier of the transferor and rights information of the digital content to be transferred, and returns the intermediate information to the transferor; the transferor in turn sends the intermediate information to the acceptor, which then sends the intermediate information to the server for right authentication; after the authentication is passed, the server generates a license for the digital content and sends it to the device of the acceptor. Through generating a license and sending it to the device of the acceptor, the user device of the acceptor is enabled to directly acquire authentication for the digital content based on the license, avoiding the process of unbinding the user device of the transferor from the digital content's rights information and the user identifier, and the process of rebinding the acceptor's user device to the user identifier and the digital content's rights information, so that the transfer flow of the digital content under copyright protection is optimized, making user operations more convenient. Wherein, the user identifier may be a user name and corresponding password information, the rights information of the digital content to be transferred may be information, such as read time, print count, of the digital content.

In the above technical solution, preferably, it further comprises: a storage unit, for binding the user identifier and usage information of the intermediate information, wherein the usage information comprises an actual use count and a preset use number.

In this technical solution, particularly, a transfer number limit is set for a digital content to be transferred for a specified transferor, i.e., the specified transferor is only allowed to send the digital content to be transferred to a predetermined number of devices. Thus through binding the usage information of the intermediate information to the user identifier, a transfer count of the digital content to be transferred corresponding to the specified transferor may be obtained readily to determine whether the transfer count of the digital content to be transferred reaches a preset number.

In the above technical solution, preferably, the authentication unit comprises: an obtaining subunit for obtaining an actual use count and a preset use number of the intermediate information corresponding to the user identifier; a determination subunit for determining whether the actual use count is less than the preset use number, wherein the authentication for the intermediate information is passed if the actual use count is less than the preset use number.

In this technical solution, through a determination made based on a use count and a preset use number in the intermediate information, use rights may be verified conveniently for the digital content's acceptor, and thus the security of the digital content may be improved.

In the above technical solution, preferably, further comprises: an encryption unit, for encrypting the intermediate information using a cryptographic scheme arranged by the authorization server, the first terminal and the second terminal, and for encrypting a license and a downloading address of the digital content to be transferred with the cryptographic scheme, sending resulting license information to the second terminal through the communication unit; a decryption unit, for decrypting the intermediate information from the second terminal with the cryptographic scheme.

In this technical solution, through encrypting a license and a downloading address of the digital content with a cryptographic scheme arranged by the server and the acceptor's user device, after receiving the license and the downloading address of the digital content, the acceptor's device is enabled to automatically decrypt the received information in an arranged manner (for example, using specified software), which further improves the security of the digital content.

A terminal is further provided in this invention, comprising: a sending unit, for sending a transfer request to an authorization server according to a user identifier of a transferor and a unique identifier of a digital content to be transferred; and sending first intermediate information from the authorization server to an acceptor terminal; and requesting the authorization server to authorize the digital content that is transferred from another terminal according to second intermediate information from the other terminal and device information of the present terminal; a receiving unit, for receiving the first intermediate information, the second intermediate information, and license information from the authorization server; an authorization unit, for using the digital content transferred from the other terminal according to the license information.

In this technical solution, on one hand, the terminal may send a user identifier and identification information of a digital content to be transferred to the server, which then may generate the first intermediate information based on the user identifier and the identification information of the digital content to be transferred and return it to the terminal, then the terminal sends the first intermediate information to the acceptor's user device, enabling the acceptor's user device to verify rights of the digital content; on the other hand, the terminal may also receive a second intermediate information transferred from another device, and request the server to authorize the received digital content according to the second intermediate information. Through the transfer of intermediate information between terminals and the authentication on the server, the process of unbinding the transferor's user device from a digital content and the process of binding an acceptor's user device to the digital content when the digital content is transferred may be avoided, making the transfer flow of a digital content under copyright protection optimized, with more convenient user operations.

In the above technical solution, preferably, further comprises: a verification unit, for verifying the second intermediate information from the other terminal, wherein after receiving from the verification unit a result that the verification is passed, the sending unit requests the authorization server to authorize the digital content transferred from the other terminal.

In this technical solution, through verifying the intermediate information received by a terminal, the security of the intermediate information received by the terminal is improved, and in turn the copyright security of the digital content is improved. Particularly, an Apabi Reader may be installed on the terminal, after receiving the intermediate information, the reader may automatically verify the intermediate information, and a request may be sent to the server only after the verification is passed.

In the above technical solution, preferably, the verification unit is further used to decrypt license information from the authorization server to obtain a downloading address and a license file, so as to obtain the digital content transferred from the other terminal according to the downloading address, and then make use of the digital content transferred from the other terminal based on the license file.

In this technical solution, through decrypting a license and a downloading address of the digital content, the terminal is enabled to automatically decrypt, after receiving license information from the server, the received information according to an arranged manner (for example, using specified software), which further improves the security of the digital content.

A method of transferring a digital content under copyright protection is further provided in this invention, comprising: when receiving a transfer request, generating intermediate information according to a user identifier of a transferor and rights information of a digital content to be transferred, and sending the intermediate information to the transferor's user device; when receiving an authorization request, authenticate the intermediate information from an acceptor's user device, and after the authentication is passed, generating a license according to the user identifier, user device information of the acceptor, and rights information of the digital content to be transferred, and then sending the license to the acceptor's user device.

In this technical solution, the server generates intermediate information according to the received user identifier of the transferor and the rights information of the digital content to be transferred, and returns the intermediate information to the transferor, which in turn sends the intermediate information to the acceptor; the acceptor sends the intermediate information to the server for rights authentication; after the authentication is passed, the server generates a license for the digital content and sends it to the acceptor's user device. Through generating the license and sending it to the acceptor's user device, the acceptor's user device is enabled to directly obtain authentication for the digital content according to the license, to avoid a process of unbinding the transferor's user device from the rights information of the digital content and the user identifier, and a process of rebinding the acceptor's user device to the user identifier and the rights information of the digital content, leading to an optimized transfer flow of the digital content under copyright protection and more convenient user operations. Wherein, the user identifier may be a user name and corresponding password information, and the rights information of the digital content to be transferred may be information such as read time, print count of the digital content and etc.

In the above technical solution, preferably, the user identifier is bound to usage information of the intermediate information, wherein the usage information comprises an actual use count and a preset use number.

In this technical solution, particularly, a transfer number limit is set for a specified transferor's digital content to be transferred, i.e., the specified transferor is only allowed to transfer the digital content to be transferred to a predetermined number of devices. Thus, through binding usage information of the intermediate information to the user identifier, a transfer count of the digital content to be transferred corresponding to the specified transferor may be obtained readily to determine whether the transfer count of the digital content to be transferred reaches a preset number.

In the above technical solution, preferably, the process of authenticating the intermediate information comprises: obtaining an actual use count and a preset use number of the intermediate information corresponding to the user identifier; determining whether the actual use count is less than the preset use number; the authentication for the intermediate information is passed if the actual use count is less than the preset use number.

In this technical solution, through making a decision based on a use count and a preset use number in the intermediate information, use rights may be verified conveniently for an acceptor of the digital content, improving the security of the digital content.

In the above technical solution, preferably, further comprises: encrypting the license and a downloading address of the digital content to be transferred with a cryptographic scheme arranged by the authorization server and the acceptor's user device, and sending the generated license information to the acceptor's user device.

In this technical solution, through encrypting the license and a downloading address of the digital content with a cryptographic scheme arranged by the server and the acceptor's user device, the acceptor's device is enabled to decrypt the received information automatically according to an arranged manner (for example, using specified software) after receiving the license and the downloading address of the digital content, which further improves the security of the digital content.

A method of transferring a digital content under copyright protection is further provided in this invention, comprising: sending a transfer request to an authorization server according to a user identifier of a transferor and a unique identifier of a digital content to be transferred; receiving a first intermediate information from the authorization server, and sending the first intermediate information to an acceptor's user device; receiving a second intermediate information from another terminal, and requesting the authorization server to authorize a digital content transferred from the other terminal according to the second intermediate information and device information of the present terminal.

In this technical solution, on one hand, the terminal may send a user identifier and identification information of a digital content to be transferred to the server, which may generate a first intermediate information based on the user identifier and the identification information of the digital content to be transferred and return it to the terminal, the terminal sends the first intermediate information to the acceptor's user device, enabling the acceptor's user device to verify rights of the digital content; on the other hand, the terminal may also receive a second intermediate information transferred from another device, and request the server to authorize the received digital content according to the second intermediate information. Through the transfer of intermediate information between terminals and the authentication on the server, the process of unbinding the transferor's user device from a digital content and the process of binding an acceptor's user device to the digital content when the digital content is transferred may be avoided, to optimize the transfer flow of a digital content under copyright protection, with more convenient user operations.

In the above technical solution, preferably, the second intermediate information from the other terminal is verified, after the verification is passed, the authorization server is requested to authorize the digital content transferred from the other terminal.

In this technical solution, through verifying intermediate information received by the terminal, the security of the intermediate information received by the terminal is improved, in turn, the copyright security of the digital content is improved. Particularly, an Apabi Reader may be installed on the terminal, after receiving intermediate information, the reader may automatically verify the intermediate information, and a request may be sent to the server only after the verification is passed.

In the above technical solution, preferably, license information from the authorization server is decrypted to obtain a downloading address and a license file, and a digital content transferred from the other terminal is obtained according to the downloading address and then is used based on the license file.

In this technical solution, through decrypting a license and a downloading address of the digital content, the terminal is enabled to automatically decrypt, after receiving license information from the server, the received information according to an arranged manner (for example, using specified software), which further improves the security of the digital content.

With technical solutions of this invention, a transferor can readily generate a reliable intermediate information file for a digital content based on his/her user identifier, and then transfer the reliable intermediate information file; an acceptor may obtain the digital content and use rights corresponding to the digital content according to the intermediate information file.

### BRIEF DESCRIPTION OF THE DRAWINGS

FIG. 1 shows a block diagram of a server according to an embodiment of the invention;

FIG. 2 shows a block diagram of a terminal according to an embodiment of the invention;

FIG. 3 shows a flowchart of a method for transferring a digital content under copyright protection according to an embodiment of the invention;

FIG. 4 shows a flowchart of a method for transferring a digital content under copyright protection according to another embodiment of the invention;

FIG. 5 shows a schematic diagram of interactions between the transferor's user device and a server according to an embodiment of the invention;

FIG. 6 shows a schematic diagram of interactions between the acceptor's user device and a server according to an embodiment of the invention.

### DESCRIPTION OF THE EMBODIMENTS

For full understanding of the above objects, features and advantageous of this invention, it will be described in further detail with reference to drawings and particular embodiments below. It should be noticed that, in the case of no conflicts, embodiments and features of embodiments of this invention may be combined with each other.

Many details will be set forth in the following description to achieve throughout understanding of this invention, however, this invention may be implemented in other ways different from those disclosed herein, and therefore the invention is not limited to the particular embodiments disclosed below.

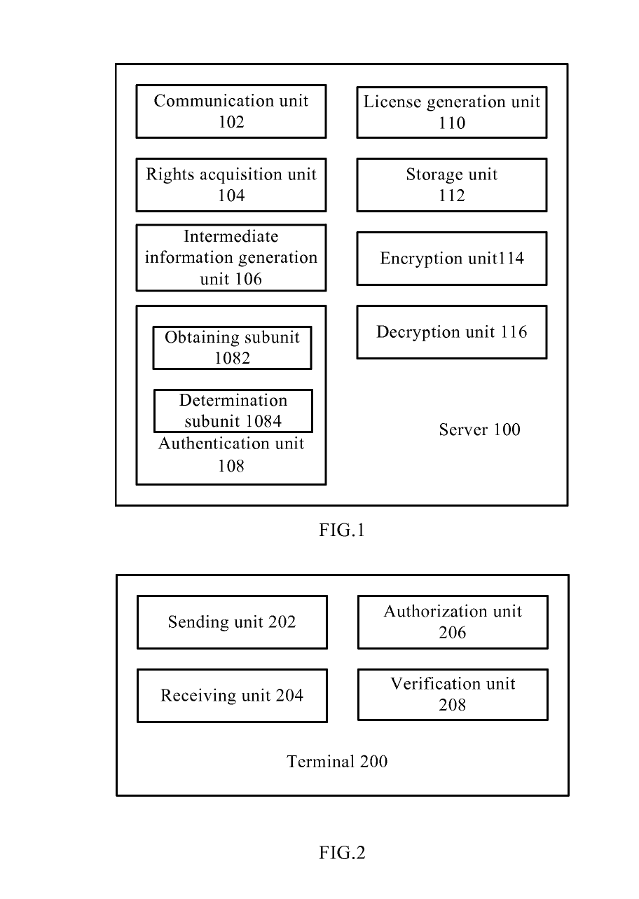

FIG. 1 shows a block diagram of a server according to an embodiment of the invention.

As shown in FIG. 1, the server 100 according to an embodiment of this invention comprises: a communication unit 102, for receiving a user identifier and a unique identifier of a digital content to be transferred, from a first terminal, and feeding back intermediate information generated by an intermediate information generation unit 106 to the first terminal, and for receiving intermediate information and second terminal device information from a second terminal, and sending a license generated by a license generation unit 110 to the second terminal; a rights acquisition unit 104, for acquiring rights information of the digital content to be transferred, according to the user identifier and the unique identifier of the digital content to be transferred; the intermediate information generation unit 106, for generating the intermediate information according to the user identifier and the rights information of the digital content to be transferred; an authentication unit 108, for authenticate the intermediate information from the second terminal; the license generation unit 110, for generating, after the authentication for the intermediate information of the second terminal is passed, a license according to the user identifier, the second terminal device information and the rights information of the digital content to be transferred.

The server generates intermediate information according to the received user identifier of the transferor and rights information of the digital content to be transferred, and returns the intermediate information to the transferor, the transferor then sends the intermediate information to the acceptor, which then sends the intermediate information to the server along with device information of his/her terminal for rights authentication; after the authentication is passed, the server generates a license for the digital content to be transferred and sends it to the user device of the acceptor. Through generating a license and sending it to the user device of the acceptor, the device of the acceptor is enabled to directly acquire authorization for the digital content based on the license, avoiding the process of unbinding the user device of the transferor from the digital content's rights information and the user identifier, and the process of rebinding the acceptor's user device to the user identifier and the digital content's rights information, so that the transfer flow of the digital content under copyright protection is optimized, making user operations more convenient. Wherein, the user identifier may be a user name and corresponding password information, the rights information of the digital content to be transferred may be information such as read time, print count, etc. of the digital content.

Information about the user device of the acceptor is sent to the authorization server to prevent random copying of an authorized digital content, enabling optimized transfer flow of the digital content while preventing random propagation of the digital content.

It should be understood that, in addition to sending intermediate information to the acceptor by the transferor, the intermediate information may be sent to the acceptor by the authorization server directly. The acceptor may make a choice on whether to put the intermediate information to use, if the intermediate information is not used by the acceptor, it may be transferred by the transferor to others, i.e., the intermediate information is common in nature, and may be used on clients having a specific application installed. Although the intermediate information is common in use, it is still under the control of the authorization server, namely, it must be authenticated by the authorization server to take effect finally (to gain authorization for the transferred digital content).

In the above technical solution, preferably, further comprises: a storage unit 112, for binding the user identifier to usage information of the intermediate information, wherein the usage information comprises an actual use count and a preset use number.

In this technical solution, particularly, a transfer number limit is set for a digital content to be transferred of a specified transferor, i.e., the transferor is only allowed to transfer the digital content to be transferred to a predetermined number of devices. Thus through binding usage information of the intermediate information to the user identifier, a transfer count of the digital content to be transferred corresponding to the specified transferor may be obtained readily to determine whether the transfer count of the digital content to be transferred reaches a preset number.

In the above technical solution, preferably, the authentication unit 108 comprises: an obtaining subunit 1082 for obtaining an actual use count and a preset use number of the intermediate information corresponding to the user identifier; a determination subunit 1084 for determining whether the actual use count is less than the preset use number, wherein the authentication for the intermediate information is passed if the actual use count is less than the preset use number.

Without providing other information to the acceptor, such as the user identifier and device information of the transferor, the transferor only needs to provide the intermediate information to the acceptor, and does not care which users might put the intermediate information in use, except for the total number of devices that make use of the intermediate information and their device information.

In the above technical solution, preferably, further comprises: an encryption unit 114, for encrypting the intermediate information with a cryptographic scheme arranged by the authorization server, the first terminal and the second terminal, and for encrypting a license and a downloading address of the digital content to be transferred with the cryptographic scheme, sending resulting license information to the second terminal through the communication unit 102; a decryption unit 116, for decrypting the intermediate information from the second terminal with the cryptographic scheme.

In this technical solution, through encrypting a license and a downloading address of the digital content with a cryptographic scheme arranged by the server and the acceptor's user device, after receiving the license and the downloading address of the digital content, the acceptor's device is enabled to automatically decrypt the received information in an arranged manner (for example, using specified software in which an agreed cryptographic scheme is built), which further improves the security of the digital content.

Thus, the authorization server may provide functions of generating a reliable intermediate information file for a digital content and parsing the intermediate information file, and thereby a function of generating a valid license, as well as a function of monitoring the validity of the intermediate information.

FIG. 2 shows a block diagram of a terminal according to an embodiment of the invention.

As shown in FIG. 2, the terminal 200 according to an embodiment of this invention comprises: a sending unit 202, for sending a transfer request to an authorization server according to a user identifier of a transferor and a unique identifier of a digital content to be transferred, and sending first intermediate information from the authorization server to an acceptor terminal, and for requesting the authorization server to authorize the digital content that is transferred from another terminal according to a second intermediate information from the other terminal, and device information of the present terminal; a receiving unit 204, for receiving the first intermediate information, the second intermediate information, and license information from the authorization server; an authorization unit 206, for using the digital content transferred from the other terminal according to the license information.

In this technical solution, on one hand, the terminal may send a user identifier and identification information of a digital content to be transferred to the server, which may generate the first intermediate information based on the user identifier and the identification information of the digital content to be transferred and return it to the terminal, the terminal sends the first intermediate information to the acceptor's user device, enabling the acceptor's user device to verify rights of the digital content; on the other hand, the terminal may also receive a second intermediate information transferred from another device, and request the server to authorize the received digital content according to the second intermediate information. Through the transfer of intermediate information between terminals and the authentication on the server, the process of unbinding the user identifier, the transferor's user device and a digital content and the process of binding an acceptor's user device to the digital content when the digital content is transferred may be avoided to optimize the transfer flow of a digital content under copyright protection, making user operations more convenient.

In the above technical solution, preferably, further comprises: a verification unit 208, for verifying the second intermediate information from the other terminal, wherein after receiving from the verification unit a result that the verification is passed, the sending unit requests the authorization server to authorize the digital content transferred from the other terminal.

In this technical solution, through verifying the intermediate information received by the terminal, the security of the intermediate information received by the terminal is improved, and thereby the copyright security of the digital content is improved. Particularly, an Apabi Reader may be installed on the terminal, after receiving the intermediate information, the reader may automatically verify the intermediate information, and a request may be sent to the server only after the verification is passed to prevent illegal intermediate information.

In the above technical solution, preferably, the verification unit 208 is further used to decrypt license information from the authorization server to obtain a downloading address and a license file, so as to obtain the digital content transferred from the other terminal according to the downloading address, and then make use of the digital content transferred from the other terminal based on the license file.

In this technical solution, through decrypting a license and a downloading address of the digital content, the terminal is enabled to automatically decrypt, after receiving license information from the server, the received information according to an arranged manner (for example, using specified software in which an agreed cryptographic scheme is built), which further improves the security of the digital content.

With a system consisted of the authorization server and the terminal described above, it can realizes that, the acceptor can make convenient use of the digital content under copyright protection provided by the transferor according to a reliable intermediate information file obtained for the digital content, i.e., the object of convenient use of the digital content by the acceptor without the need for the transferor to provide his/her user identifier.

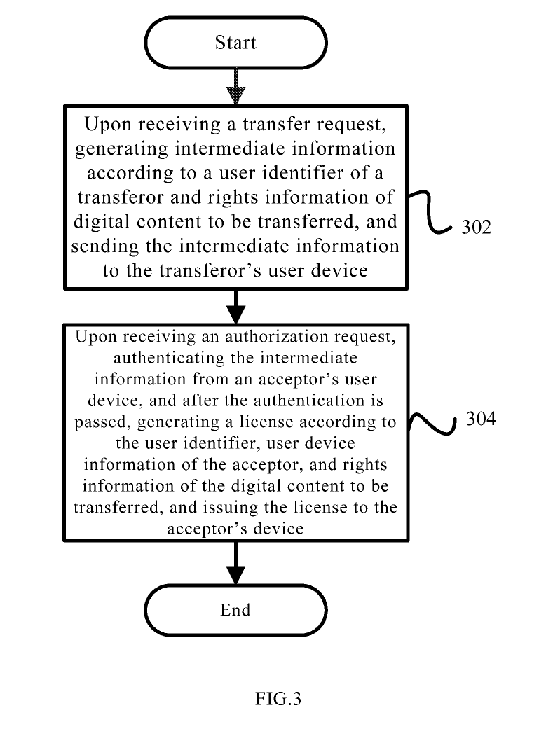

FIG. 3 shows a flowchart of a method for transferring a digital content under copyright protection according to an embodiment of the invention.

As shown in FIG. 3, a method of transferring a digital content under copyright protection according to an embodiment of the invention comprises: at step 302, when receiving a transfer request, generating intermediate information according to a user identifier of a transferor and rights information of a digital content to be transferred, and sending the intermediate information to the transferor's user device; at step 304, when receiving an authorization request, authenticate the intermediate information from an acceptor's user device, and after the authentication is passed, generating a license according to the user identifier, user device information of the acceptor, and rights information of the digital content to be transferred, and sending the license to the acceptor's user device.

The server generates intermediate information according to the received user identifier of the transferor and the rights information of the digital content to be transferred, and then returns the intermediate information to the transferor, which in turn sends the intermediate information to the acceptor; the acceptor sends the intermediate information and his/her terminal device information to the server for rights authentication; after the authentication is passed, the server generates a license for the digital content to be transferred and sends it to the acceptor's user device. Through generating the license and sending it to the acceptor's user device, the acceptor's user device is enabled to directly obtain authentication for the digital content according to the license, to avoid a process of unbinding the transferor's user device from the rights information of the digital content and the user identifier, and a process of rebinding the acceptor's user device to the user identifier and the rights information of the digital content, leading to an optimized transfer flow of the digital content under copyright protection and more convenient user operations. Wherein, the user identifier may be a user name and corresponding password information, and the rights information of the digital content to be transferred may be information such as read time, print count etc., of the digital content.

Information about the user device of the acceptor is sent to the authorization server to prevent random copying of an authorized digital content, enabling optimized transfer flow of the digital content while preventing random propagation of the digital content.

In the above technical solution, preferably, the user identifier is bound to usage information of the intermediate information, wherein the usage information comprises an actual use count and a preset use number.

In this technical solution, particularly, a transfer number limit is set for a specified transferor's digital content to be transferred, i.e., the specified transferor is only allowed to transfer the digital content to be transferred to a predetermined number of devices. Thus, through binding usage information of the intermediate information to the user identifier, a transfer count of the digital content to be transferred corresponding to the specified transferor may be obtained readily to determine whether the transfer count of the digital content to be transferred reaches a preset number.

In the above technical solution, preferably, the process of authenticating the intermediate information comprises: obtaining an actual use count and a preset use number of the intermediate information corresponding to the user identifier; determining whether the actual use count is less than the preset use number, wherein the authentication for the intermediate information is passed if the actual use count is less than the preset use number.

Without providing other information to the acceptor, such as the user identifier and device information of the transferor, the transferor only needs to provide the intermediate information to the acceptor, and does not care which users put the intermediate information in use, except for the total number of devices that make use of the intermediate information and their device information.

In the above technical solution, preferably, further comprises: encrypting the license and a downloading address of the digital content to be transferred with a cryptographic scheme arranged by the authorization server and the acceptor's user device, and sending generated license information to the acceptor's user device.

In this technical solution, through encrypting the license and a downloading address of the digital content with a cryptographic scheme arranged by the server and the acceptor's user device, the acceptor's user device is enabled to decrypt the received information automatically according to an arranged manner (for example, using specified software) after receiving the license and the downloading address of the digital content, which further improves the security of the digital content.

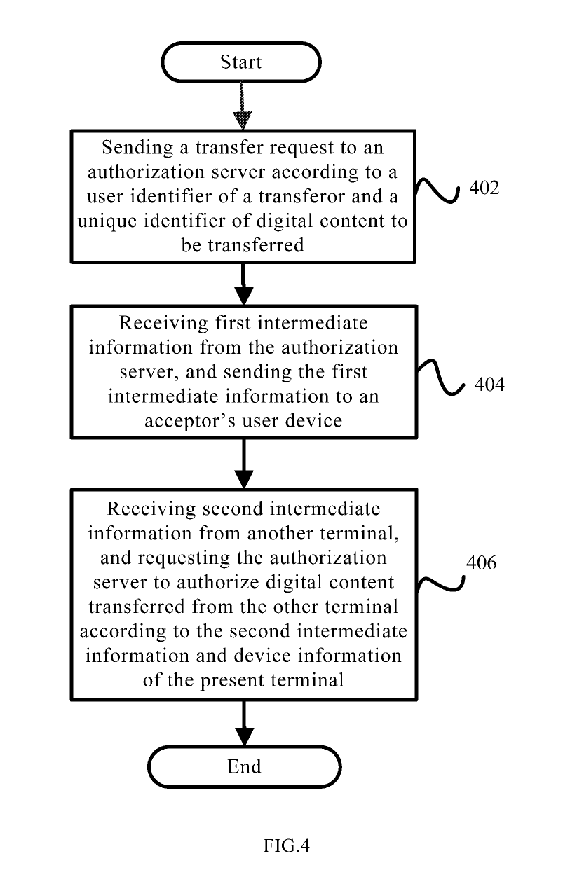

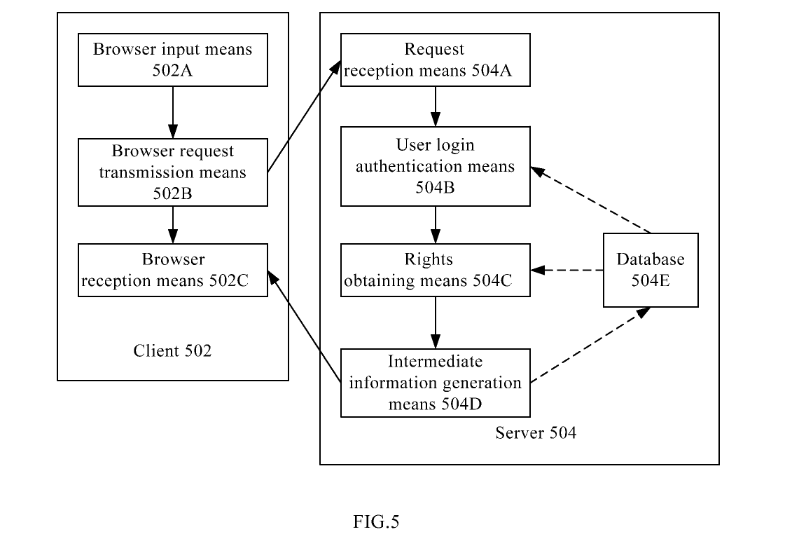

FIG. 4 shows a flowchart of a method for transferring a digital content under copyright protection according to another embodiment of the invention.

As shown in FIG. 4, a method of transferring a digital content under copyright protection according to another embodiment of this invention comprises: at step 402, sending a transfer request to an authorization server according to a user identifier of a transferor and a unique identifier of a digital content to be transferred; at step 404, receiving first intermediate information from the authorization server, and sending the first intermediate information to an acceptor's user device; at step 406, receiving a second intermediate information from another terminal, and requesting the authorization server to authorize a digital content transferred from the other terminal according to the second intermediate information and device information of the present terminal.

In this technical solution, on one hand, the terminal may send a user identifier and identification information of a digital content to be transferred to the server, the server may generate the first intermediate information based on the user identifier and the identification information of the digital content to be transferred and return it to the terminal, the terminal sends the first intermediate information to the acceptor's user device, enabling the acceptor's user device to verify rights of the digital content; on the other hand, the terminal may also receive a second intermediate information transferred from another device, and request the server to authorize the received digital content according to the second intermediate information. Through the transfer of intermediate information between terminals and the authentication on the server, the process of unbinding the transferor's user identifier, user device and a digital content and the process of binding an acceptor's user device, user identifier and the digital content when the digital content is transferred may be avoided, to optimize the transfer flow of a digital content under copyright protection, with more convenient user operations.

In the above technical solution, preferably, the second intermediate information from the other terminal is verified, wherein after the verification is passed, the authorization server is requested to authorize the digital content transferred from the other terminal.

In this technical solution, through verifying intermediate information received by the terminal, the security of the intermediate information received by the terminal is improved, and the copyright security of the digital content is improved accordingly. Particularly, an Apabi Reader may be installed on the terminal, after receiving intermediate information, the reader may automatically verify the intermediate information, and a request may be sent to the server only after the verification is passed.

In the above technical solution, preferably, license information from the authorization server is decrypted to obtain a downloading address and a license file, and a digital content transferred from the other terminal is obtained according to the downloading address and then is used based on the license file.

In this technical solution, through decrypting a license and a downloading address of the digital content, the terminal is enabled to automatically decrypt, after receiving license information from the server, the received information according to an arranged manner, which further improves the security of the digital content.

Thus, in order to protect copyright of the digital content, the digital content provider may perform copyright control based on a DRM license. Before the use of the digital content by a user, the authorization server needs to authorize according to the user identifier and a specific device, of the user, only after that can the user use the digital resource content normally on the specific device. If the user wants to replace the device, it is necessary for the digital content provider to reauthorize a new device for replacement. If the user wants to transfer the digital content while keeping the number of authorized devices unchanged, the transferor of the digital content only needs to provide reliable intermediate information, and based on the reliability of the intermediate information of the digital content, the acceptor of the digital content can make use of the digital content under authorization control after binding a license to the device information.

FIG. 5 shows a schematic diagram of interactions between the transferor's user device and a server according to an embodiment of the invention.

As shown in FIG. 5, the interaction flow between the transferor's user device (i.e., client 502) and the server 504 according to an embodiment of this invention is as follows:

Client 502: obtaining user identifier information provided by the digital content provider; according to the user identifier information obtained presently, selecting a digital content to be transferred; selecting the user identifier to be sent to the server 504 and the digital content to be transferred by a browser input means 502A;

Browser request transmission means 502B for sending a request to the authorization server 504;

Server 504:

Request reception means 504A: receiving the user identifier information of the transferor and a unique ID of the digital content; sending data to user login authentication means 504B;

User login authentication means 504B: performing login authentication after the request reception means 504A receives the user identifier; if the login authentication is passed, initiating a request for generating reliable intermediate information to be sent corresponding to the digital content, and sending data to rights obtaining means 504C;

Rights obtaining means 504C: according to the user identifier and the unique ID of the digital content, obtaining a list of use rights for the accessed digital content from a database 504E on the server 504, and sending data to intermediate information generation means 504D;

Intermediate information generation means 504D: generating intermediate information corresponding to the user identifier and the digital content, wherein the intermediate information comprises the user identifier information, the unique ID of the digital content, rights list information of the digital content, a network address of the authorization server 504. The user identifier information is a user identifier that is associated in authorizing the digital content, which is synchronized on the server 504; the rights list information of the digital content represents rights of making use of the digital content after resource authorization, such as use time, etc. The user identifier information, the unique ID of the digital content, the rights list information of the digital content are encrypted according to an algorithm to get a digital signature; wherein the key is internal data on the client 502, and is synchronized on the server 504;

Client 502:

Browser reception means 502C: acquiring intermediate information corresponding to the digital content generated on the server 504; the transferor may transfer this intermediate information, which is bound to user identifier information of the transferor, with a use number limit that is set according to a preset number corresponding to the user identifier of the transferor.

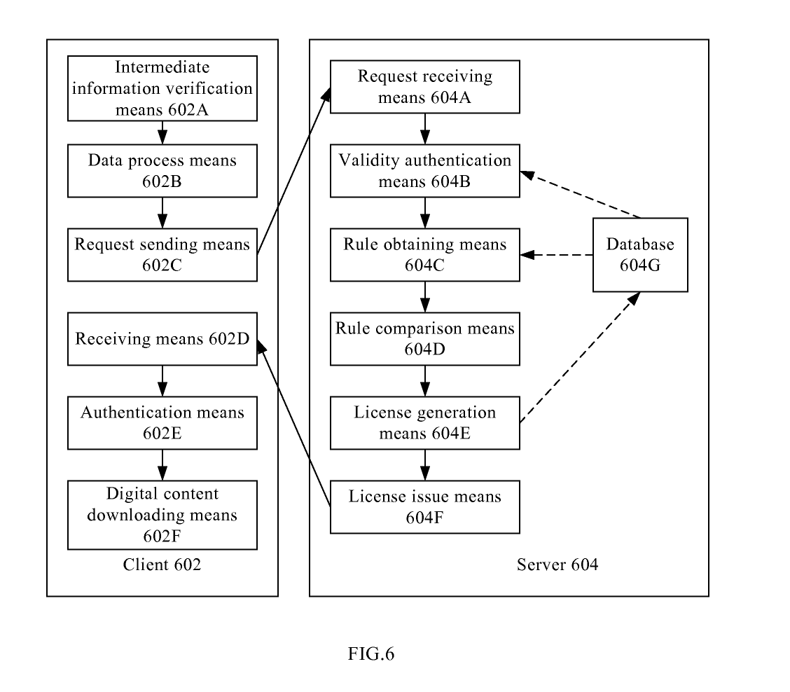

FIG. 6 shows a schematic diagram of interactions between the acceptor's user device and the server according to an embodiment of the invention.

As shown in FIG. 6, the interaction flow between the acceptor's user device (i.e., client 602) and the server 604 according to an embodiment of this invention is as follows:

Client 602:

Intermediate information verification means 602A: after the acceptor's user device (i.e., client 602) receives intermediate information, it needs to be opened in a specified way (for example, application “Apabi Reader”); when opened, data validity may be verified by a built-in cryptographic module; if it is valid, acceptor's user device information is obtained;

Data process means 602B: signing the acceptor's user device information, user identifier information, authorized items of the digital content and a shift identifier in an encryption process, and then sending to the request sending means 602C;

Request sending means 602C: sending plaintext of the intermediate information, the acceptor's user device information, and the digital signature to the server 604.

Server 604:

Request receiving means 604A: after parsing request data obtained from the client 602, sending it to the validity authentication means 604B of the server 604 for validity authentication control;

Validity authentication means 604B: according to an internal private key of the server 604, decrypting the digital signature of the request to get parsed data, and then according to data obtained through parsing the plaintext of the intermediate information, determining whether this request is valid; if it is valid, sending data to the rule obtaining means 604C;

Rule obtaining means 604C: according to the user identifier in the intermediate information, obtaining a use count of the current intermediate information file from a database 604G, and sending data to the rule comparison means 604D;

Rule comparison means 604D: if use count of the intermediate information is within an allowed range, sending data to the license generation means 604E;

License generation means 604E: according to the user identifier information, the acceptor's user device information, the unique ID of the digital content, and the digital content rights, generating a corresponding license, and at the same time generating a unique license ID based on the time and a random number; the server 604 records this operation in the database 604G, parses license generation completion information and a downloading address used for the digital resource, generate a digital signature with a cryptographic scheme arranged with the client 602, and send it to the license issue means 604F along with the plaintext information of the intermediate information;

License issue means 604F for sending the license to the client 602.

Client 602:

Receiving means 602D: obtaining license information issued by the server 604, sending data to the authentication means 602E on the client 602;

Authentication means 602E: decrypting data with a cryptographic scheme arranged with the server 604, if successful, requesting the server 604 to download a corresponding encrypted digital content according to a digital content downloading address in the decrypted data;

Digital content downloading means 602F: after the client 602 downloads the encrypted digital content, the acceptor may make use of the digital content authorized and encrypted.

Another embodiment according to this invention is as follows.

A user logs into a website e.g., APABI CHINA DIGITAL LIBRARY, using a user name and a password, selects an eBook resource to be transferred, clicks a button for transferring eBook resource, requests the server to generate an intermediate information file to be transferred. When the user clicks the button to initiate the request, the current user name, the password, and a unique ID of the eBook resource are sent to the server.

The authorization server receives and authenticates the current user name and the password; if passed, a rights list of the digital content is obtained according to the user name and unique ID of the eBook resource, for example, seven days the eBook resource may be opened by the user and may be printed 50 times (since the license is generated). The authorization server generates an intermediate information file for the eBook resource, including the user name, the unique ID of the eBook resource, an expiry date, a print count, a rights list of the digital content and a network address of the authorization server.

The user obtains the intermediate information file returned by the authorization server, and transfers the current intermediate information to a friend (acceptor).

The friend (acceptor) uses a client application, such as “Apabi Reader”, double clicks to open the intermediate information file. Apabi Reader first checks the validity of the intermediate information file corresponding to the resource, if valid, it accesses the user identifier information and device information of the present device, the print limit and the expiry date, and the digital content rights list information, encrypts with a preset key information of the reader to get a digital signature, and then send the intermediate information and the digital signature to the specified authorization server.

The authorization server receives the above intermediate information and the digital signature data, decrypts according to a cryptographic scheme synchronized with the client's reader. If requested data is decrypted successfully, it sends all resolved data to rule calculation means.

The rule calculation means queries a database to find out a use count of the intermediate information file corresponding to the current user and a preset use number according to the information obtained above, and sends result data of the calculation to rule comparison means.

The rule comparison means compares the use count of the intermediate information file and the preset number stored in the database; if the use count of the intermediate information file is less than the preset number stored in the database, it sends data information to license generation means.

The license generation means generates a corresponding license according to the user identifier information, the acceptor's user device information, the unique ID of the digital content, and the digital content rights, and obtains a digital signature through encryption with a key, sends the license and the digital signature to license issue means, which returns data to Apabi Reader for use.

Apabi Reader receives returned data, then decrypts with a key in the device. If successful, it generates a license file based on two rights (the print count, the expiry date of reading), the resource identifier, and the device ID, then downloads the book according to an obtained downloading path. After the downloading is completed, the acceptor may make use of the eBook legally based on the generated license file.

Technical solutions of this invention have been described in detail with reference to drawings. In this invention, intermediate information is generated according to the user identifier of the transferor and rights information of the digital content; the acceptor obtain use authority of the digital content according to the received intermediate information, so that the transfer flow of the digital content is optimized, based on the validity of the intermediate information of the digital content, enabling the user to have autonomous control on device binding and use of the digital content according to the intermediate information while realizing copyright protection for digital contents communicated over the network.

One skilled in the art should understand that, the embodiments of this application may be provided as a method, a system, or a computer program product. Therefore, this application may be in the form of full hardware embodiments, full software embodiments, or a combination thereof. Moreover, this application may be in the form of a computer program product that is implemented on one or more computer-usable storage media (including, without limitation, magnetic disk storage, CD-ROM and optical storage) containing computer-usable program codes.

This application is described referring to the flow chart and/or block diagram of the method, device (system) and computer program product according to the embodiments of this application. It should be understood that, each flow and/or block in the flow chart and/or block diagram and the combination of flow and/or block in the flow chart and/or block diagram may be realized via computer program instructions. Such computer program instructions may be provided to the processor of a general-purpose computer, special-purpose computer, a built-in processor or other programmable data processing devices, to produce a machine, so that the instructions executed by the processor of a computer or other programmable data processing devices may produce a device for realizing the functions specified in one or more flows in the flow chart and/or one or more blocks in the block diagram.

Such computer program instructions may also be stored in a computer-readable storage that can guide a computer or other programmable data processing devices to work in a specific mode, so that the instructions stored in the computer-readable storage may produce a manufacture including a commander equipment, wherein the commander equipment may realize the functions specified in one or more flows of the flow chart and one or more blocks in the block diagram.

Such computer program instructions may also be loaded to a computer or other programmable data processing devices, so that a series of operational processes may be executed on the computer or other programmable devices to produce a computer-realized processing, thereby the instructions executed on the computer or other programmable devices may provide a process for realizing the functions specified in one or more flows in the flow chart and/or one or more blocks in the block diagram.

Although preferred embodiments of this application have been described above, other variations and modifications can be made by one skilled in the art in the teaching of the basic creative conception. Therefore, the preferred embodiments and all these variations and modifications are intended to be contemplated by the appended claims.

What are described above are merely preferred embodiments of the present invention, but do not limit the protection scope of the present invention. Various modifications or variations can be made to this invention by persons skilled in the art. Any modifications, substitutions, and improvements within the scope and spirit of this invention should be encompassed in the protection scope of this invention.

What is claimed is:

1. A server comprising:
a communication unit for receiving a user identifier and a unique identifier of digital content to be transferred from a first terminal, and feeding back intermediate information generated by an intermediate information generation unit to the first terminal;
and for receiving intermediate information and second terminal device information from a second terminal, and sending a license generated by a license generation unit to the second terminal;
a rights acquisition unit for acquiring, according to the user identifier and the unique identifier of the digital content to be transferred, rights information of the digital content to be transferred;
the intermediate information generation unit for generating the intermediate information according to the user identifier and the rights information of the digital content to be transferred;
an authentication unit for authenticate the intermediate information from the second terminal; and
the license generation unit for generating, after the authentication for the intermediate information of the second terminal is passed, a license according to the user identifier, the second terminal device information and the rights information of the digital content to be transferred.

2. The server according to claim 1 further comprising:
a storage unit for binding the user identifier and usage information of the intermediate information, wherein the usage information comprises an actual use count and a preset use number.

3. The server according to claim 2 wherein the authentication unit comprises:
an obtaining subunit for obtaining an actual use count and a preset use number of the intermediate information corresponding to the user identifier; and
a determination subunit for determining whether the actual use count is less than the preset use number, wherein the authentication for the intermediate information is passed if the actual use count is less than the preset use number.

4. The server according to claim 1 further comprising:
an encryption unit for encrypting the intermediate information using a cryptographic scheme arranged by the authorization server, the first terminal and the second terminal, and for encrypting a license and a downloading address of the digital content to be transferred with the cryptographic scheme, sending the resulting license information to the second terminal through the communication unit; and
a decryption unit for decrypting the intermediate information from the second terminal with the cryptographic scheme.

5. A terminal comprising:
a sending unit for sending a transfer request to an authorization server according to a user identifier of a transferor and a unique identifier of digital content to be transferred, and sending a first intermediate information from the authorization server to an acceptor terminal, and for requesting, according to second intermediate information from another terminal, device information of the present terminal, the authorization server to authorize the digital content that is transferred from the other terminal;
a receiving unit for receiving the first intermediate information, the second intermediate information, and license information from the authorization server; and
an authorization unit for using the digital content transferred from the other terminal according to the license information.

6. The terminal according to claim 5 further comprising:
a verification unit for verifying the second intermediate information from the other terminal, wherein after receiving a from the verification unit a result that the verification is passed, the sending unit requests the authorization server to authorize the digital content transferred from the other terminal.

7. The terminal according to claim 6 wherein the verification unit is further used to decrypt license information from the authorization server to obtain a downloading address and a license file, so as to obtain the digital content transferred from the other terminal according to the downloading address, and make use of the digital content transferred from the other terminal based on the license file.

8. A method of transferring a digital content under copyright protection comprising:
upon receiving a transfer request, generating intermediate information according to a user identifier of a transferor and rights information of digital content to be transferred, and sending the intermediate information to the transferor's user device;
upon receiving an authorization request, authenticating the intermediate information from an acceptor's user device, and after the authentication is passed, generating a license according to the user identifier, user device information of the acceptor, and rights information of the digital content to be transferred, and issuing the license to the acceptor's user device.

9. The method according to claim 8 wherein the user identifier is bound to usage information of the intermediate information, wherein the usage information comprises an actual use count and a preset use number.

10. The method according to claim 9 wherein the process of authenticating the intermediate information comprises:
obtaining an actual use count and a preset use number of the intermediate information corresponding to the user identifier;
determining whether the actual use count is less than the preset use number;
the authentication for the intermediate information is passed if the actual use count is less than the preset use number.

11. The method according to claim 10 further comprising:
encrypting the license and a downloading address of the digital content to be transferred with a cryptographic scheme arranged by the authorization server and the acceptor's user device, and sending the generated license information to the acceptor's user device.

12. A method of transferring a digital content under copyright protection comprising:
sending a transfer request to an authorization server according to a user identifier of a transferor and a unique identifier of digital content to be transferred;
receiving a first intermediate information from the authorization server, and sending the first intermediate information to an acceptor's user device; and
receiving a second intermediate information from another terminal, and requesting the authorization server to authorize digital content transferred from the other terminal according to the second intermediate information and device information of the present terminal.

13. The method according to claim 12 wherein the second intermediate information from the other terminal is verified, wherein after the verification is passed, the authorization server is requested to authorize the digital content transferred from the other terminal.

14. The method according to claim 13 wherein license information from the authorization server is decrypted to obtain a downloading address and a license file, so that digital content transferred from the other terminal is obtained according to the downloading address and is used based on the license file.
